(19) United States
(12) Patent Application Publication
(10) Pub. No.: US 2021/0216132 A1
(43) Pub. Date: Jul. 15, 2021

(54) Systems and Methods for Generating Sensory Input Associated with Virtual Objects

(71) Applicant: Spark XR, Inc., Salt Lake City, UT (US)

(72) Inventors: Jonathan Dean, Sandy, UT (US); Jeffrey Peters, Sandy, UT (US); Artaches Haroutunian, Cottonwood Heights, UT (US)

(21) Appl. No.: 16/644,493

(22) PCT Filed: Oct. 28, 2019
(86) PCT No.: PCT/US2019/058384

§ 371 Date: Mar. 4, 2020

Related U.S. Application Data
(60) Provisional application No. 62/760,792, filed on Nov. 13, 2018.

(51) Int. Cl. G06F 3/01; G06T 11/00; A63F 13/28

(52) U.S. Cl. CPC G06F 3/011; G06T 11/00; A63F 2300/302; G06F 2203/012; A63F 2300/8082; A63F 13/28

(57) ABSTRACT

A technology is described for generating sensory effects linked to virtual objects. In one example, a virtual object associated with a sensory attribute can be generated in a virtual reality environment. The virtual object may be associated with a sensory attribute which can be simulated using a defined sensory input generated by a sensory rendering device. A virtual object position can be determined for the virtual object relative to a virtual user position for a virtual user in the virtual reality environment. One or more sensory rendering devices can be identified to generate the defined sensory input, and the one or more sensory rendering devices can be activated to generate the defined sensory input.

### BACKGROUND

Virtual reality (VR) is an interactive computer-generated experience taking place within a simulated environment. The simulated environment can be similar to the real world or it can be fantastical, creating an experience that is not possible in ordinary physical reality. VR technology commonly uses virtual reality headsets or multi-projected environments, sometimes in combination with physical environments to generate realistic images and sounds that simulate a user's physical presence in a virtual or imaginary environment. A user via virtual reality equipment can view a virtual reality environment, move throughout the virtual reality environment, and interact with virtual objects. Applications of virtual reality can include entertainment (e.g., gaming), telecommunications (e.g., conference meetings), educational purposes (i.e. medical or military training), as well as other applications.

### BRIEF DESCRIPTION OF THE DRAWINGS

FIG. 1 is a block diagram illustrating an example simulation system for generating a virtual reality environment and sensory input to simulate sensory attributes of virtual objects included in the virtual reality environment.

FIG. 2 is a diagram that illustrates the concept of sensory input intensity associated with sensory attributes of a virtual object.

FIG. 3 is a diagram illustrating the concept of simulating sensory attributes of a virtual object in a physical game environment.

FIG. 4 is a flow diagram that illustrates an example method for generating sensory input linked to virtual objects included in a virtual reality environment.

FIGS. 5A-B are diagrams that illustrate example sensory rendering apparatuses that can be used to generate sensory input linked to virtual objects included in a virtual reality environment.

FIG. 6 is block diagram illustrating an example of a computing device that can be used to execute a method for generating dynamic sensory effects linked to virtual objects included in a virtual reality environment.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a sensory input” includes reference to one or more of such features and reference to “subjecting” refers to one or more such steps.

As used herein, the term “substantially” is used to provide flexibility and imprecision associated with a given term, metric, or value. The degree of flexibility for a particular variable can be readily determined by one skilled in the art.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Present Technology

Technologies are described for dynamically generating sensory effects linked to virtual objects that exist within a virtual reality environment. The sensory effects may be generated using sensory rendering devices strategically positioned within a physical system environment to deliver defined sensory inputs to a user. A physical system environment may be an enclosed physical space, such as a room or a sensory pod structure, which has sensory rendering devices strategically positioned within the physical space to enable sensory effects to be dynamically generated in association with sensory attributes expressed by a virtual object located in a virtual reality environment. As an example, a user located within the physical system environment and who is viewing a virtual reality environment using a head-mounted device can be presented with a virtual object that exists within the virtual reality environment. The virtual object can represent an actual object that has physical elements or an imaginary object that has attributed physical elements which can be sensed by way of a sensory input like touch, smell, sight, taste, and/or hearing.

As part of presenting a virtual object to a user in a virtual reality environment, one or more sensory attributes associated with the virtual object can be identified, and the sensory attributes can be simulated using one or more sensory rendering devices. A sensory device can include any device that is capable of producing a sensory input (e.g., heat, cold, air current, sound, vibration, mist, etc.) detectable by human senses. The sensory input can be dynamically generated and directed to match the dynamic movement, intensity, and/or manifestation of a sensory attribute exhibited by a virtual object located in a virtual reality environment. For example, dynamic movement associated with a virtual object and/or a virtual user in relation to the virtual object can be simulated by dynamically directing sensory input generated by one or more sensory rendering devices at a location within a physical system environment (e.g., via an actuator, a track system, a cable or wire system, and/or a series of sensory rendering devices). A virtual intensity of the virtual object can be simulated by dynamically varying an amount of sensory input generated by the sensory rendering devices (e.g., by dynamically altering the degrees of voltage and/or duration of same voltage in real time, to the sensory device to vary sensory input). An intensity of a sensory input to be generated by a sensory rendering device can be calculated based in part on (i) a virtual distance between a virtual object and a virtual user and (ii) features of the virtual object, such as size, strength, force, weight, duration, composition, and the like.

As an illustration of the concepts described above, a virtual direction and intensity of a virtual fireball can be simulated using one or more heat radiating devices located within a physical system environment. A heat radiating device can be activated to simulate heat radiating from the virtual fireball onto the user, and the heat generated by the heat radiating device can be dynamically directed to the user in relation to virtual movement of the virtual fireball and/or virtual movement of the virtual user in relation to the virtual fireball. The amount of heat generated by the heat radiating device can also be dynamically adjusted in relation to the movement of the virtual fireball and/or the virtual user, and in relation to the features (intensity, size, etc.) of the virtual fireball. For example, an amount of heat from the virtual fireball may increase when a virtual distance between the virtual user and the virtual fireball increases or when the size of the virtual fireball increases, and the amount of heat may decrease when the virtual user moves farther away from the virtual fireball or when the size of the virtual fireball decreases. Thus, the sensory input simulating a heat attribute of the virtual fireball can be dynamically adjusted to correspond to a user's control of virtual user navigation of the virtual reality environment and dynamic changes to the features the virtual fireball.

In the past, sensory input generated in association with physical and virtual objects has been linear, pre-programmed, or scripted. As a result of the present technology, sensory effects can be variable and dynamic using systems that interpolate virtual reality environment data with sensory device systems to deliver non-linear and non-scripted sensory input that corresponds with a dynamic virtual reality environment. In particular, sensory input can be generated using sensory rendering devices to deliver heat, cold, wind, mist, smell, and other sensory inputs to correspond to various features of a virtual object.

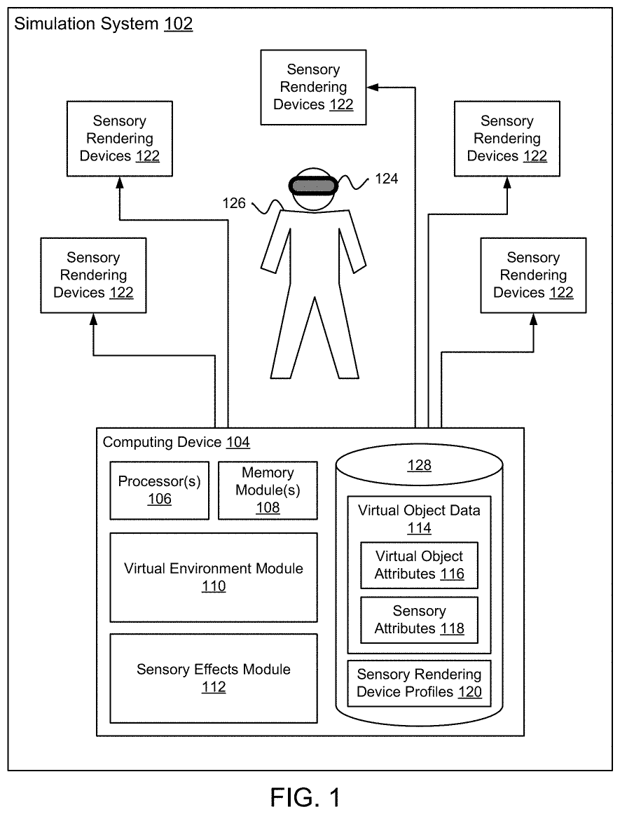

To further describe the present technology, examples are now provided with reference to the figures. FIG. 1 is a diagram illustrating a high level example of a simulation system 102 (or other system) that can be used to generate a virtual reality (VR) environment and sensory effects to simulate variable and dynamic sensory attributes of virtual objects included in the virtual reality environment. A virtual reality environment may comprise a computer generated environment that includes images, sounds, and other sensations that simulates a user's physical presence in a computer generated environment. A virtual reality environment can also include an augmented reality (AR) environment, a mixed reality (MR) environment, as well as other types of virtual reality environments including projection and display systems requiring no glasses or headsets to immerse a user in a virtual environment. An augmented reality environment may comprise a direct or indirect view of a physical, real-world environment whose elements are augmented by computer-generated sensory input, such as sound, video, and graphics. A mixed reality environment may comprise merging a real world and a virtual world to produce a new environment and visualizations where physical and digital objects co-exist and interact in real-time.

As illustrated, the simulation system 102 can include a computing device 104 and one or more sensory rendering devices 122, as well as other simulation system components. The sensory rendering devices 122 can be arranged to create a sensory rendering grid that at least partially surrounds a user 126. The sensory rendering devices 122 included in the simulation system 102 can be configured to generate defined sensory inputs to simulate sensory attributes 118 of a virtual object that exists within a virtual reality environment. A defined sensory input can be used to stimulate a human sense, including tactile, auditory, thermoception, olfactory, taste, and kinesthesia human senses. A defined sensory input can include any device generated input (e.g., heat, cold, air, sound, vibration, light, smell, taste, etc.) which can be perceived using one or more human senses as being associated with one or more sensory attributes of a virtual object. A sensory input can be defined based on sensory attributes of a virtual object. Sensory attributes of a virtual object can include, but are not limited to, type (tactile, auditory, thermoception, olfactory, taste, and kinesthesia), intensity, volume, tempo, duration, and other sensory attributes, and the sensory input can be generated to simulate the sensory attributes from a physical position that correlates to a virtual position of the virtual object relative to a user.

Sensory rendering devices 122 can be strategically positioned (e.g., in a grid) within the simulation system 102 to deliver defined sensory inputs that simulate the sensory attributes 118 of a virtual object in a virtual reality environment and correspond to a position and intensity of the virtual object even when the position and intensity of the virtual object changes over a time period. Examples of sensory rendering devices 122 that can be used to generate defined sensory inputs can include, but are not limited to, fans, misters, air jets (hot and cold), heaters, speakers, actuated platforms, shaker motors, as well as any other type of sensory rendering device 122 that can be used to generate a sensory input that stimulates a human sense. As will be appreciated, a plurality of sensory inputs can be generated using one or more sensory rendering devices 122. As an illustration, a hot air jet can be used to simulate heat and wind sensory attributes 118 of a virtual object in combination with a base speaker to simulate a vibration sensory attribute 118 of the virtual object. Also, in some examples, a series of sensory rendering devices 122 can be used to simulate movement of a virtual object within a virtual reality environment. For example, a series of sensory rendering devices 122 can be activated and deactivated to simulate dynamic movement of a virtual object within a virtual reality environment.

The computing device 104 can include a virtual reality environment module 110, sensory effects module 112, a data store 128, and other system components. The virtual reality environment module 110 may be configured to generate a virtual reality environment and output data to a display device configured to display the virtual reality environment. A virtual reality environment may comprise a three-dimensional computer generated environment, within which, a user 126 can explore and interact with virtual objects using a display device 124 and/or game controllers. The user 126 can be immersed within the virtual reality environment and manipulate virtual objects or perform a series of actions within the virtual reality environment. A user 126 may view the virtual reality environment using the display device 124. The display device 124 can include a head-mounted device (e.g., head-mounted displays, eyeglasses, contact lenses, virtual retinal displays, etc.). In some examples, instead of a head-mounted device, other types of display devices 124 can be used, such as hand held devices, mobile devices, HUDs (Head-Up Displays), projection systems, 360 degree display rooms, and other devices configured to display a virtual reality environment. A user 126 can use game controllers that have motion sensing capabilities to interact with a virtual reality environment.

The virtual reality environment module 110 may be configured to generate one or more virtual objects to include in a virtual reality environment. A virtual object may be a computer generated three-dimensional object that has a location in three-dimensional space relative to, and independent of, a user position. A virtual object can be used to represent any visual aspect of a computer generated environment, including the terrain of a virtual world and any objects that exist in the virtual world. A virtual object may represent an actual object (e.g., a physical object) or an imaginary object that has attributed physical elements which can be sensed via human sense receptors. As an illustration, a virtual object may be a virtual fireball that has the sensory attribute of fire which can be simulated using heat and wind. The virtual reality environment module 110 can be configured to generate a virtual object in response to an event. For example, a virtual object can be created in response to a virtual user entering a virtual space in a virtual reality environment. In response to the event, the virtual reality environment module 110 obtains virtual object data 114 for the virtual object from the data store 128 and creates the virtual object in the virtual reality environment using the virtual object data 114. The virtual object data 114 may comprise a data structure that includes virtual object attributes 116 and sensory attributes 118. The virtual object attributes 116 can include, but are not limited to, visual appearance, movement, user interaction, virtual reality environment interaction, and other attributes of the virtual object. The sensory attributes 118 can represent physical elements of the virtual object that can be simulated using sensory input, such as heat, cold, sound, vibration, forced air, mist, or any other sensory input associated with a physical element attributed to a virtual object 114. As an example, virtual object data 114 for a fire tornado can include a heat sensory attribute and a wind sensory attribute, which can represent the physical elements of the fire tornado.

As part of creating a virtual object in a virtual reality environment, the virtual reality environment module 110 may be configured to query virtual object data 114 associated with the virtual object for one or more sensory attributes 118 and calculate an intensity for each sensory attribute 118 based in part on the proximity of a virtual user to the virtual object in the virtual reality environment. For example, the virtual reality environment module 110 can calculate a virtual distance between the virtual object and a virtual user in the virtual reality environment, and the virtual reality environment module 110 can use the virtual distance to determine an intensity of the sensory attribute 118 that is relative to the proximity of the virtual user to the virtual object in the virtual reality environment. The sensory attribute 118 can be simulated by the simulation system 102 using a sensory rendering device 122 to generate a sensory input at the intensity that is relative to the proximity of the virtual user to the virtual object in the virtual reality environment.

Additional factors can be used to calculate a sensory input intensity for a sensory attribute 118. For example, some virtual object attributes 116, such as size, strength, composition, duration, etc. may impact an intensity of a sensory input, and therefore, these virtual object attributes 116 can be used in calculating sensory input intensity. As an illustration, the size of a virtual fireball may determine in part an amount of heat and wind that is generated by the virtual fireball. A lifespan of a virtual object can be used to determine in part a duration of a sensory input (e.g., a plume of fire that erupts from a volcano). Also, virtual object attributes 116 that are variable can impact an intensity of a sensory input, and the sensory input intensity can be periodically recalculated to account for changes to the virtual object. For example, a variable virtual object attribute 116 may cause a virtual object to change size, strength, composition, etc. which has an impact on sensory input intensity. As an illustration, a variable virtual object attribute 116 for a virtual fireball may cause the size of the virtual fireball to expand and shrink. As the virtual fireball expands and shrinks, the sensory input intensity for the virtual fireball can be recalculated to correspond with the changing size of the virtual fireball.

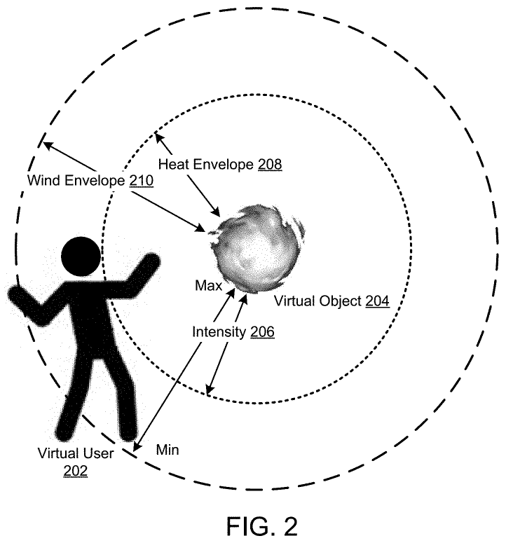

The concept of sensory input intensity is illustrated in FIG. 2. As shown, a virtual object 204 (a virtual fireball) may be associated with heat and wind sensory attributes generated by the virtual object 204. The heat and wind sensory attributes may be contained within sensory envelopes 208 and 210 which define boundaries for the heat and wind sensory attributes. In particular, the heat sensory attribute may be contained within a heat envelope 208, and the wind sensory attribute may be contained within a wind envelope 210. The intensity 206 of the heat and wind sensory attributes may change within the sensory envelopes based on a virtual distance from the virtual object 204. For example, the intensity 206 of the heat and wind sensory attributes may be greatest near or at the virtual object 204, and may be least near or at the outer boundary of the sensory envelopes 208 and 210. Accordingly, an intensity of a sensory attribute may be calculated based in part on the location of the virtual user 202 within a sensory envelope 208 and 210. For example, a virtual user position within a three-dimensional space can be used to determine a virtual user's location within a sensory envelope 208 and 210, and the location of the virtual user 202 within the sensory envelope 208 and 210 can be used to determine a sensory input intensity for a sensory attribute associated with the sensory envelope 208 and 210.

Returning to FIG. 1, after calculating the intensity of a sensory attribute 118, the virtual reality environment module 110 may be configured to send instructions to the sensory effects module 112 to activate a sensory rendering device 122 to simulate the sensory attribute 118 at the intensity specified by the virtual reality environment module 110. The sensory effects module 112 may be configured to identify a sensory rendering device 122 to simulate the sensory attribute 118 of the virtual object and activate the sensory rendering device 122 (e.g., via an electronic instruction to switch on the sensory rendering device 122) to generate the sensory input at the sensory input intensity. For example, the instructions provided by the virtual reality environment module 110 can include a sensory attribute 118 and sensory input intensity information. The sensory effects module 112 may use the sensory attribute 118 to identify a sensory rendering device profile 120 for a sensory rendering device 122 that is configured to simulate the sensory attribute 118. The sensory rendering device profile 120 may include information for individual sensory rendering devices 122, such as device type (e.g., fan, heat device, air jet device, mister device, etc.), a sensory rendering device position (e.g., a position of a sensory rendering device within the simulation system 102 that can be correlated to a virtual object position within a three-dimensional space relative to a position of a virtual user), and device attributes (degree of movement, intensity range, etc.). As an illustration, instructions to the sensory effects module 112 may include parameters that include a heat attribute, a virtual object position, and a sensory attribute intensity. The sensory effects module 112 can use the heat attribute and the virtual object position to query sensory rendering device profiles 120 and identify a sensory rendering device 122 that is configured to generate radiating heat and is located in the simulation system 102 in a position that substantially corresponds to the virtual object position and sensory intensity.

A position of a sensory rendering device 122 that substantially corresponds to a position of a virtual object in a virtual reality environment may be a difference between the position of the virtual object in the virtual reality environment, as perceived by the user 126, and the position of the sensory rendering device 122 in the simulation system 102 that generates sensory input directed to the user 126. The difference between the virtual object position and the source of a sensory input (i.e., a rendering device) may be undiscernible to the user 126 who is viewing the virtual object in the virtual reality environment and sensing the sensory input. However, as will be appreciated, a sensory rendering device position that substantially corresponds to a virtual object position in a virtual reality environment can be a distance from a few inches to a few feet as perceived by a user 126 who is viewing a virtual object using a display device 124 and receiving sensory input generated by a sensory rendering device 122. In one example, a sensory rendering device position that substantially corresponds to a virtual object position in a virtual reality environment can be from zero to thirty-six inches, as perceived by a user 126 viewing the virtual object using a display device 124 and receiving sensory input generated by a sensory rendering device. As used herein, the term “substantially” refers to the complete or nearly complete extent or degree of an action, characteristic, property, state, structure, item, or result. The exact allowable degree of deviation from absolute completeness can in some cases depend on the specific context. As will be appreciated, a sensory rendering device position that substantially corresponds to a virtual object position in a virtual reality environment will depend in part on a configuration of a sensory rendering system and placement of sensory rendering devices 122 within the sensory rendering system.

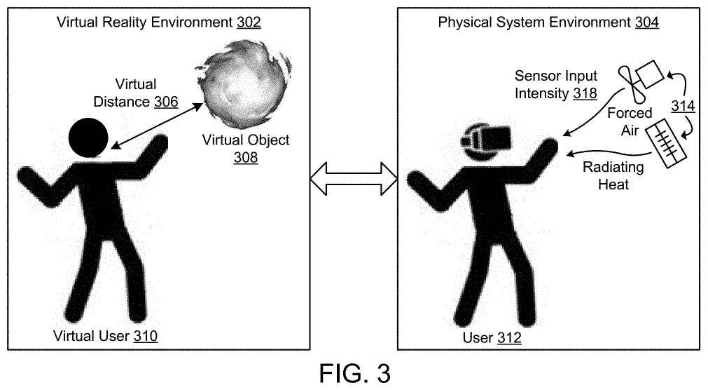

FIG. 3 illustrates the concept of simulating sensory attributes of a virtual object 308 in a physical game environment 304. As illustrated, sensory attributes of a virtual object 308 (a virtual fireball) in a virtual reality environment 302 can be simulated within a physical game environment 304 using sensory rendering devices 314. The sensor input intensity 318 generated by the sensory rendering device 314 may be based in part on a virtual distance 306 between the virtual user 310 and the virtual object 308 (e.g., the proximity of the virtual user 310 to the virtual object 308), as described above. For example, an amount of heat generated by a heat radiating device, and an amount of forced air generated by a fan device, may be determined by the virtual distance 306 between the virtual user 310 and the virtual object 308. Accordingly, a user 312 may receive sensory input generated by the sensory rendering devices 314 at an intensity and from a position that substantially correlates to sensory attributes of the virtual object 308 in the virtual reality environment 302.

Returning again to FIG. 1, in one example, the virtual reality environment module 110 may be configured to track a position of a virtual object and a virtual user, and in response to detecting that the virtual object position or the virtual user position in the virtual reality environment has changed, the virtual reality environment module 110 can instruct the sensory effects module 112 to activate one or more sensory rendering devices 122 that substantially correspond to the virtual object position relative to the virtual user position in the virtual reality environment, and deactivate one or more sensory rendering devices 122 that no longer substantially correspond to the virtual object position relative to the virtual user position in the virtual reality environment. For example, as a virtual user and/or a virtual object move around the virtual reality environment, the movement can be tracked, and sensory rendering devices 122 can be activated and deactivated according to the movement of the virtual user and/or the virtual object. As an illustration, the movement of a virtual fireball can be tracked as the virtual fireball circles a virtual user, and the movement of the virtual fireball can be simulated by activating and deactivating sensory rendering devices 122 that correspond to the position and movement of the virtual fireball circling the virtual user. As a result, a user 126 using a display device 124 can see the virtual fireball circle around the user and feel the virtual fireball, via sensory input generated by the sensory rendering devices 122, circling the user 126.

The various processes and/or other functionality contained within the computing device 104 may be executed on one or more processors 106 that are in communication with one or more memory modules 108. The simulation system 102 can include a number of computing devices 104 that are arranged, for example, in one or more server banks or computer banks, or other arrangements. A data store 128 can store virtual object data 114 for a plurality of virtual objects. The virtual object data 114 can include virtual object attributes 116 and sensory attributes 118 of a virtual object. A data store 128 can also store sensory rendering device profiles 120. The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store 128 may include storage systems such as a SAN (Storage Area Network), cloud storage network, volatile or non-volatile RAM, optical media, or hard-drive type media. The data store 128 may be representative of a plurality of data stores 128 as can be appreciated. API calls, procedure calls, inter-process calls, or other commands can be used for communications between the modules.

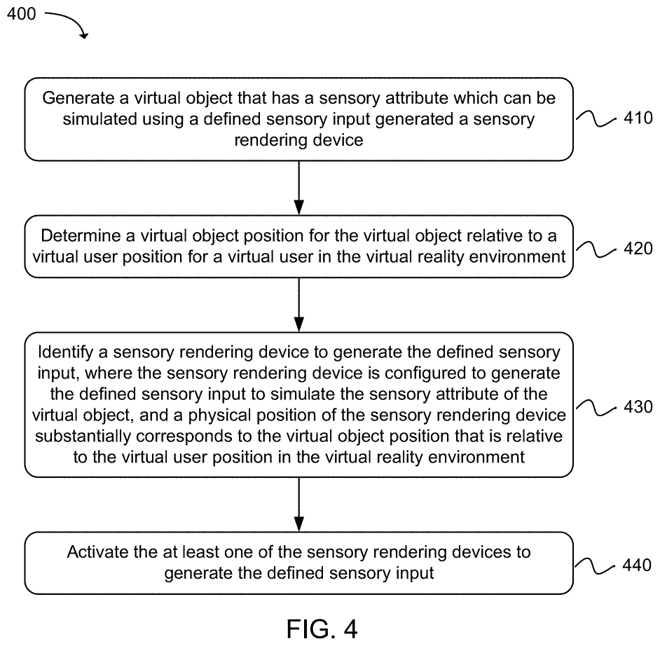

FIG. 4 is a flow diagram that illustrates an example method 400 for generating sensory effects linked to virtual objects included in a virtual reality environment. In particular, sensory rendering devices can be configured to generate defined sensory inputs associated with sensory attributes of virtual objects that exist within the virtual reality environment. The sensory rendering devices can be arranged to deliver the defined sensory inputs to a user who is viewing the virtual reality environment via a display device, such as a head mounted display.

Referring now to block 410, a virtual object can be generated in a virtual reality environment, where the virtual object has a sensory attribute which can be simulated using a defined sensory input generated by one or more sensory rendering devices. A sensory attribute of a virtual object can specify a feature of the virtual object that can be simulated using a sensory input, as well as specify additional sensory information that can be used to generate sensory input, such as intensity, volume, and/or duration. In one example, multiple virtual objects can be created in the virtual reality environment, where individual virtual objects can be associated with one or more sensory attributes simulated using one or more sensory rendering devices.

As in block 420, a virtual object position for the virtual object can be determined relative to a virtual user position for a virtual user in the virtual reality environment. Thereafter, as in block 430, a sensory rendering device can be identified to generate the defined sensory input, where the sensory rendering device is configured to generate at least a portion of the defined sensory input to simulate the sensory attribute of the virtual object, and a physical position of the sensory rendering device substantially corresponds to the virtual object position that is relative to the virtual user position in the virtual reality environment. As part of identifying a sensory rendering device, a sensory type (tactile, auditory, thermoception, olfactory, taste, and kinesthesia) associated with a sensory attribute of a virtual object can be identified, and a sensory rendering device can be identified that is configured to generate a defined sensory input that is of the sensory type. As an example, a sensory type associated with a virtual fire tornado can be identified as thermoception, and a sensory rendering device configured to generate heat can be selected to generate sensory input that simulates heat emanating from the virtual fire tornado.

As in block 430, the sensory rendering device can be activated to generate the defined sensory input. For example, an electronic instruction can be sent to control system that activates and deactivates the rendering device. Activating a sensory rendering device to generate a defined sensory input can include simulating multiple sensory attributes of a virtual object, including, but not limited to, intensity, volume, and duration.

As one example, activating a sensory rendering device to generate a defined sensory input can further include determining an intensity of the sensory input. As an example, the sensory input intensity can be based in part on a virtual distance between a virtual object position and a virtual user position, and the sensory rendering device can be activated to simulate the sensory input intensity. As an example, a virtual distance between a virtual user and a virtual fire tornado can be used to determine an intensity of heat and wind to generate. In some examples, a virtual object attribute can indicate in part an intensity of the sensory attribute of the virtual object, and the virtual object attribute can be used as part of calculating the sensory input intensity. As an example, a size and composition of a virtual fire tornado can be used to determine an intensity of heat and wind associated with the size and composition of the virtual fire tornado. Also, the intensity of the sensory input can be recalculated at defined intervals based in part on an updated virtual distance between the virtual object and the virtual user in the virtual reality environment.

As another example, activating a sensory rendering device to generate a defined sensory input can include determining an input volume for the sensory input based in part on a sensory attribute of a virtual object, and a sensory rendering device can be activated to generate the defined sensory input at the input volume. As an example, a sensory attribute of a virtual fire tornado can indicate an amount wind that is associated with a virtual fire tornado, and a forced air device can be activated to simulate the amount of wind emanating from the virtual fire tornado. In some examples, multiple sensory rendering devices can be activated to generate a defined sensory input at an input volume indicated by a sensory attribute of a virtual object.

In another example, activating a sensory rendering device to generate a defined sensory input can include activating a first sensory rendering device to simulate a first sensory attribute of a virtual object, and activating a second sensory rendering device to simulate a second sensory attribute of the virtual object. As an example, a heating device can be activated to simulate heat radiating from a virtual fire tornado, and a forced air device can be activated to simulate wind generated in association with the virtual fire tornado.

In yet another example, activating a sensory rendering device to generate a defined sensory input can include determining a duration of time to generate the defined sensory input based in part on a sensory attribute of the virtual object, and activating the sensory rendering device to generate the defined sensory input for the duration of time. As an example, a sensory attribute of a virtual fire tornado can include a burst of fire that periodically emanates from the virtual fire tornado. A sensory attribute of the virtual fire tornado can specify a duration of a burst of fire, and a heated air jet device can be activated for the duration of time to generate a burst of hot air that simulates the virtual burst of fire emanating from the virtual fire tornado.

As will be appreciated, a sensory rendering device may be configured to simulate multiple sensory attributes of a virtual object, and the sensory rendering device can be used to generate sensory input that simulates one or more of the sensory attributes of the virtual object. A virtual object can be terminated in response to a termination event, and any sensory rendering devices used to simulate sensory attributes of the virtual object can be deactivated.

Referring again to block 410, in some examples, as part of generating a virtual object in a virtual reality environment, the virtual object can be positioned in the virtual reality environment to substantially correspond to a position of a sensory rendering device capable of simulating a sensory attribute of the virtual object. As an illustration, a virtual sun can be created in a virtual reality environment to be in a virtual position that substantially corresponds to a physical position of a heat radiating device, and the heat radiating device can be used to generate heat that simulates the heat radiating from the virtual sun.

In another example, a positioning system can be used to position a sensory rendering device to substantially correspond to a virtual object position relative to a virtual user position in a virtual reality environment. The positioning system can comprise an actuator, a track system, a cable or wire system, as well as other types of positioning systems. The positioning system can be used to move a sensory rendering device from one position to another position that substantially corresponds to a virtual position of a virtual object relative to a virtual position of a user in a virtual reality environment.

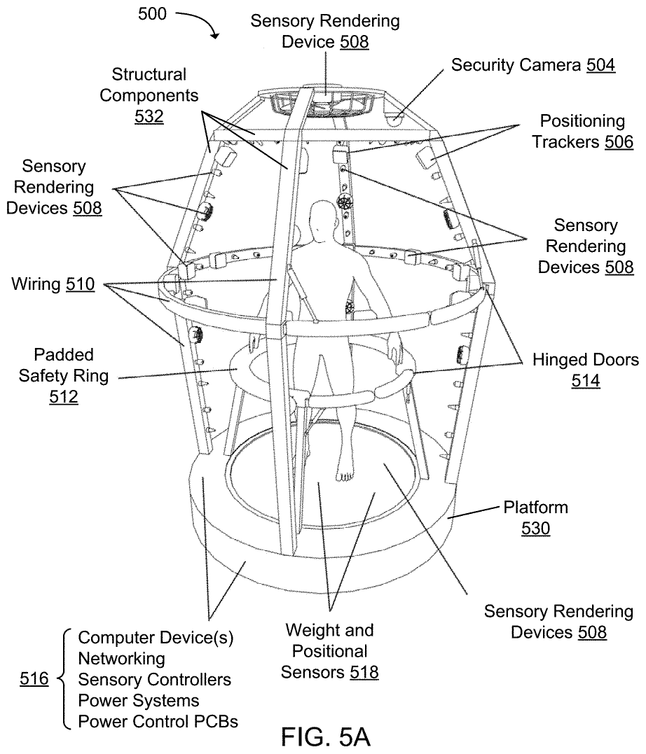

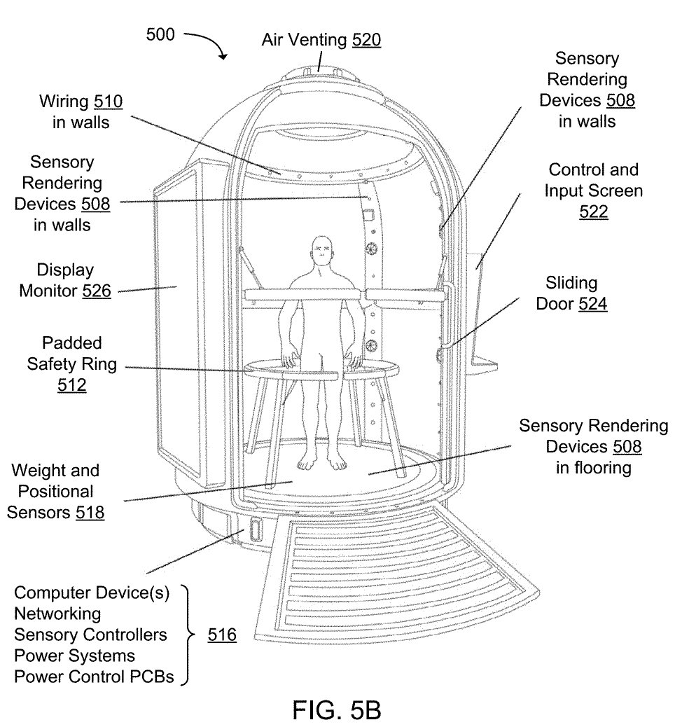

Moving now to FIGS. 5A-B, examples of a sensory rendering apparatus 500 or sensory rendering system is illustrated in accordance with various examples of the technology. The sensory rendering apparatus 500 can be used to deliver an immersive digital experience to users that includes entertainment and gaming, instruction, training, virtual tourism, gambling, simulation, and other types of personal experiences that includes sight, sound, and sensory effects that work in concert with each other to deliver the digital experience to the users.

A sensory rendering apparatus 500 can include a plurality of sensory rendering devices 508 which can be positioned within the sensory rendering apparatus 500 in a 360-degree configuration to deliver defined sensory inputs to a user located within the interior of the sensory rendering apparatus 500. The sensory rendering apparatus 500 can include hardware systems configured to receive input from software systems and perform switching and voltage variability to control sensory rendering devices 508 and generate sensory input that simulates intensity of sensory attributes of virtual objects. More specifically, the sensory rendering apparatus 500 can include control and power systems 516 comprising computer devices, networking devices, sensory controllers, power systems, and/or power control PCBs which can be used to control sensory rendering devices 508 and other components of the sensory rendering apparatus 500 to deliver defined sensory inputs to a user located within the interior of the sensory rendering apparatus 500. In particular, the sensory rendering apparatus 500 can be used to implement the simulation system described earlier in association with FIG. 1.

As illustrated in FIG. 5A, in one example, a sensory rendering apparatus 500 can include a structure that includes a platform 530 and a plurality of structural components 532 (e.g., rods, beams, struts, and ties) arranged to create an interior or enclosed portion that includes the platform 530. Sensory rendering devices 508 can be placed on and within the platform 530 and the structural components 532 in an arrangement that allows the sensory rendering devices 508 to be used to deliver sensory input to a user to simulate one or more sensory attributes of a virtual object. The sensory rendering apparatus 500 can include positioning trackers 506 used to track a position and movement of a user within the enclosed portion of the sensory rendering apparatus 500. The positioning trackers 506 can be attached to the structural components 532 sensory rendering apparatus 500. One or more security cameras 504 used to monitor activity within the enclosed portion of the sensory rendering apparatus 500 can be attached to the structural components 532 of sensory rendering apparatus 500. Wiring 510 that connects various components of the sensory rendering apparatus 500 (e.g., sensory rendering devices 508, positioning trackers 506, security cameras 504, and sensors 518) to the control and power systems 516 can be attached to the structural components 532. Also, the interior portion of the sensory rendering apparatus 500 can include additional structural components that provide safety and stability to a user. For example, the sensory rendering apparatus 500 can include a safety ring 512 that provides a boundary of movement to a user. The sensory rendering device 508 can include hinged doors 514 to allow entry and exit to and from the interior portion of the sensory rendering device 508.

As indicated above, sensory rendering devices 508 can include a series of sensors and devices that generate and deliver different types of sensory textures and sensations. A sensory rendering device 508 can include, but is not limited to, a wind generator, bass shaker, transducer, solenoid-based knocker, shaker motor, heat generating device, cooling system, mister, olfactory delivery device, as well as any other type of sensory rendering device 508 that can be activated by control and power systems 516 to generate and deliver a sensory input to a user. In one example, control and power systems 516 included in the sensory rendering apparatus 500 can be configured to cause one or more sensory rendering devices 508 to generate sensory input to have a particular “sensory texture”. For example, a sensory texture can comprise one or more sensory inputs (e.g., light, sound, vibration, heat, cold, etc.) generated to deliver a particular physical sensation using volume, intensity, tempo, harmonics, and other sensory input attributes. The sensory texture of sensory input generated by the sensory rendering devices 508 can correspond to a sensory attribute of a virtual object and/or virtual event in a virtual reality environment. As a non-limiting example, the sensory texture of virtual machine gun fire occurring in a virtual reality environment can be generated using a combination of sensory inputs generated using an audio speaker and a solenoid-based knocker to match an intensity and tempo of the virtual machine gun fire.

A sensory rendering apparatus 500 can support various types of bodily mounted or hand held peripherals, controllers, sensory floor, treadmill, or other devices that allow actions by a user that can be translated into movement, locomotion, or interaction of a virtual user within a virtual reality environment. This can include weapon peripherals, sensors in the platform 530 that can track a user's movement, weight or foot placement, treadmills that simulate walking, camera-based motion detectors, or any other device that allows a user to interact with a virtual reality environment. For example, a sensory rendering apparatus 500 can include a movable platform 530 configured to simulate a virtual terrain in a virtual reality environment. In one example, a floor of the platform 530 can be dynamically reconfigured to simulate a virtual terrain. As one example, as a user navigates a virtual reality environment, the platform 530 can be positioned at various angles to simulate uneven ground in the virtual reality environment. As another example, the platform 530 can include air inflatable cells which can be activated to generate textures of a terrain that simulate a virtual terrain of a virtual reality environment. In another example, the platform 530 can include pressure sensors positioned to generate pressure sensor data which can be used to track feet and weight distribution for use in controlling a virtual user in a virtual reality environment.

Visual components of a virtual reality environment can be presented to a user via a head-mounted display (HMD), augmented reality headset (AR), mixed reality googles (XR), interior based LCD or LED screens (including a floor comprising an LCD or LED display), interior projection screens, or other types of visual rendering. Audio delivered to a user can be configured via on or off ear speakers, headsets headphones, earbuds, speakers mounted within the interior of the sensory rendering apparatus 500 or other audio system that can deliver a three-dimensional sound scape that corresponds to virtual events occurring in a virtual reality environment.

As illustrated in FIG. 5B, an exterior of a sensory rendering apparatus 500 can be covered to isolate the interior portion of the sensory rendering apparatus 500 from an external environment. The covering can include any suitable material, including plastic and/or metal coverings. A sensory rendering apparatus 500 may comprise a cabinet of any shape and size that allows for mounting and securing of visual and sensory components to deliver a sensory immersion experience to a user within the sensory rendering apparatus 500. For example, the cabinet can be a circular shape with a round base and top, a square shape, a sphere shape, or any other appropriate shape. The cabinet can be sized to allow a child or average sized adult to stand, sit, or lie down within an interior of the cabinet. In some examples, the cabinet can be sized to accommodate multiple users at a single time. In one example, the cabinet can include air venting 520 to allow venting of air from the interior of the cabinet. One or more display monitors 526 and/or control and input screens can be attached to the exterior of the cabinet. A sliding door 524 can be installed to further isolate the interior of the sensory rendering apparatus 500 from an exterior environment. Sensory rendering devices 508 and wiring 510 can be installed in the walls of the sensory rendering apparatus 500. Also, rendering devices 508, weight and positional sensors 518, and control and power systems 516 can be installed under the flooring of the platform 530.

A sensory rendering apparatus 500 can include multiple safety layers directed to a user that can come in a variety of forms including a waist high safety ring 512, padded interior walls, heat dampeners, and safety meshes, including other physical forms of safety mechanisms. A sensory rendering apparatus 500 can be configured for a single user experience or combined (via digital networking) with other sensory rendering apparatuses 500 to provide a multi-user experience. For example, multiple users can go into their own individual sensory rendering apparatuses 500 and choose the same virtual reality title and then experience that same virtual reality world together, at the same time, each within their own individual sensory rendering apparatus 500.

A sensory rendering apparatus 500 can be configured to include stackable components that allow the sensory rendering apparatus 500 to be disassembled and reassembled, and to allow transport of the sensory rendering apparatus 500 from one venue to another as needed. Each component of the sensory rendering apparatus 500 can be sized to fit through an average doorway (business or residential). In one example, a sensory rendering apparatus 500 can be managed remotely via a computer network. For example, software updates (e.g., operating system updates and application updates) can be sent to a sensory rendering apparatus 500 over a computer network that includes a LAN, WAN, the Internet, cellular network, and the like. Likewise, software titles can be sent to a sensory rendering apparatus 500 from a main server. Multiple sensory rendering apparatuses 500 can have their software updated at once using a remote distribution system.

While the various figures described herein illustrate example systems and apparatuses that may implement the techniques above, many other similar or different system configurations are possible. The example systems and apparatuses discussed and illustrated above are merely representative and not limiting.

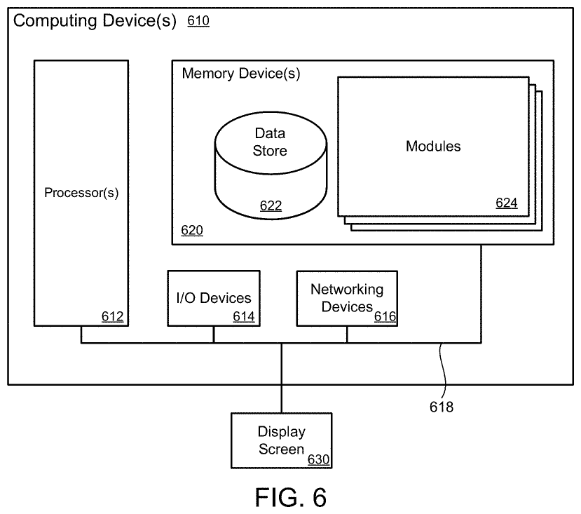

FIG. 6 illustrates a computing device 610 on which modules of this technology may execute. A computing device 610 is illustrated on which a high-level example of the technology may be executed. The computing device 610 may include one or more processors 612 that are in communication with memory devices 620. The computing device 610 may include a local communication interface 618 for the components in the computing device. For example, the local communication interface 618 may be a local data bus and/or any related address or control busses as may be desired.

The memory device 620 may contain modules 624 that are executable by the processor(s) 612 and data for the modules 624. For example, the memory device 620 may include a virtual reality environment module, a sensory effects module, and other modules. The modules 624 may execute the functions described earlier. A data store 622 may also be located in the memory device 620 for storing data related to the modules 624 and other applications along with an operating system that is executable by the processor(s) 612.

Other applications may also be stored in the memory device 620 and may be executable by the processor(s) 612. Components or modules discussed in this description that may be implemented in the form of software using high-level programming languages that are compiled, interpreted or executed using a hybrid of the methods.

The computing device may also have access to I/O (input/output) devices 614 that are usable by the computing devices. An example of an I/O device 614 is a display screen 630 that is available to display output from the computing device 610. Another example of an I/O device 614 is one or more sensory rendering devices configured to generate sensory input associated with the at least one sensory attribute. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor(s) 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory device 620 may represent multiple memory units that operate in parallel to the processing circuits. This may provide parallel processing channels for the processes and data in the system. The local communication interface 618 may be used as a network to facilitate communication between any of the multiple processors and multiple memories. The local communication interface 618 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A sensory rendering apparatus, comprising:
a plurality of sensory rendering devices configured to generate defined sensory inputs associated with sensory attributes of virtual objects in a virtual reality environment, wherein the plurality of sensory rendering devices are arranged to deliver the defined sensory inputs to a user;
a computing system configured to:
determine a virtual object position for a virtual object relative to a virtual user position for a virtual user in a virtual reality environment;
correlate the virtual object position to a device position of at least one sensory rendering device included in the plurality of sensory rendering devices configured to generate the defined sensory input to substantially correspond to the sensory attribute of the virtual object; and
activate the at least one sensory rendering device to generate the defined sensory input.

2. The sensory rendering apparatus as in claim 1, wherein the plurality of sensory rendering devices are arranged in a 360-degree configuration to deliver the defined sensory inputs to an area located within the 360-degree configuration.

3. The sensory rendering apparatus as in claim 1, wherein the plurality of sensory rendering devices are arranged to create a sensory rendering grid, and a series of sensory rendering devices are activated and deactivated based in part on the virtual object position relative to the virtual user position in the virtual reality environment.

4. The sensory rendering apparatus as in claim 1, further comprising a positioning system to position the plurality of sensory rendering devices to substantially correspond to virtual object positions for virtual objects relative to the virtual user position in the virtual reality environment.

5. The sensory rendering apparatus as in claim 1, further comprising a platform configured with pressure sensors which generate pressure sensor data to track feet position and weight distribution of the user.

6. The sensory rendering apparatus as in claim 1, further comprising a platform that includes one or more sensory rendering devices configured to transmit sensory textures via a floor of the platform.

7. The sensory rendering apparatus as in claim 1, further comprising a head mounted display, one or more display devices, or a projection system configured to display the virtual reality environment to the user.

8. A computer implemented method, comprising:
generating a virtual object that has a sensory attribute which can be simulated using a defined sensory input generated by at least one sensory rendering device;
determining a virtual object position for the virtual object relative to a virtual user position for a virtual user in a virtual reality environment;
identifying the at least one sensory rendering device to generate the defined sensory input, wherein the at least one sensory rendering device is configured to generate the defined sensory input to substantially correspond to the sensory attribute of the virtual object, and the at least one sensory rendering device is positioned to substantially correspond to the virtual object position that is relative to the virtual user position in the virtual reality environment; and
initiating activation of the sensory rendering device to generate the defined sensory input.

9. The method as in claim 8, wherein identifying the at least one sensory rendering device further comprises:
identifying a sensory type associated with the sensory attribute of the virtual object; and
identifying the at least one sensory rendering device as being configured to generate the defined sensory input that is of the sensory type.

10. The method as in claim 8, wherein initiating activation of the sensory rendering device to generate the defined sensory input further comprises:
determining a sensory input intensity based in part on a virtual distance between the virtual object position and the virtual user position; and
initiating activation of the sensory rendering device to simulate the sensory input intensity.

11. The method as in claim 10, further comprising calculating the sensory input intensity based in part on a virtual object attribute that indicates in part an intensity of the sensory attribute of the virtual object.

12. The method as in claim 10, further comprising recalculating at defined intervals the sensory input intensity based in part on an updated virtual distance between the virtual object and the virtual user in the virtual reality environment.

13. The method as in claim 8, wherein initiating activation of the sensory rendering device to generate the defined sensory input further comprises:
initiating activation of a first sensory rendering device to simulate a first sensory attribute of the virtual object; and
initiating activation of a second sensory rendering device to simulate a second sensory attribute of the virtual object.

14. The method as in claim 8, wherein initiating activation of the sensory rendering device to generate the defined sensory input further comprises:
determining a duration of time to generate the sensory input based in part on the sensory attribute of the virtual object; and
initiating activation of the sensory rendering device to generate the defined sensory input for the duration of time.

15. The method as in claim 8, wherein initiating activation of the sensory rendering device to generate the defined sensory input further comprises:
determining an input volume for the sensory input based in part on the sensory attribute of the virtual object; and
initiating activation of the sensory rendering device to generate the defined sensory input at the input volume.

16. The method as in claim 15, further comprising initiating activation of multiple sensory rendering devices to generate the defined sensory input at the input volume.

17. The method as in claim 8, wherein creating the virtual object in the virtual reality environment further comprises positioning the virtual object in the virtual reality environment to substantially correspond to a position of the sensory rendering device which is configured to generate the defined sensory input to simulate the sensory attribute of the virtual object.

18. A non-transitory machine readable storage medium including instructions embodied thereon, the instructions when executed by one or more processors:
generate a virtual object in a virtual reality environment, wherein the virtual object is associated with a sensory attribute which can be simulated using a defined sensory input generated by at least one sensory rendering device;
calculate a virtual distance between the virtual object and a virtual user in the virtual reality environment;
calculate a sensory input intensity based in part on the virtual distance and the sensory attribute of the virtual object;
identify the at least one sensory rendering device to generate the defined sensory input, wherein the at least one sensory rendering device is configured to generate the defined sensory input to simulate the sensory attribute of the virtual object, and a physical position of the at least one sensory rendering device substantially corresponds to a virtual object position that is relative to a virtual user position in the virtual reality environment; and
initiate activation of the at least one sensory rendering device to generate the defined sensory input at the sensory input intensity.

19. The non-transitory machine readable storage medium in claim 18, wherein the sensory attribute of the virtual object specifies a feature of the virtual object that can be simulated using the defined sensory input, and specifies sensory information used to generate the defined sensory input.

20. The non-transitory machine readable storage medium in claim 18, further comprising instructions that when executed by the one or more processors cause the one or more processors to terminate the virtual object in response to a termination event and initiate deactivation of the at least one sensory rendering device.
